(19) United States
(12) Patent Application Publication
(10) Pub. No.: US 2013/0081766 A1
(43) Pub. Date: Apr. 4, 2013

(54) INSULATION BLIND AND BLIND ASSEMBLY

(71) Applicant: Denis Bourdon, Ottawa (CA)

(72) Inventor: Denis Bourdon, Ottawa (CA)

(73) Assignee: ALVEUS INNOVATIONS INC., Ottawa (CA)

(21) Appl. No.: 13/371,900

(22) Filed: Feb. 13, 2012

Related U.S. Application Data
(60) Provisional application No. 61/540,667, filed on Sep. 29, 2011.

(51) Int. Cl. E06B 9/24; E06B 7/00

(52) U.S. Cl. 160/127; 160/379

(57) ABSTRACT

A blind and blind assembly are provided for reducing or eliminating the flow of air between the blind and an opening at which the blind is installed. A blind is provided for an opening in a structure, the blind comprising a flexible blind sheet portion, at least one slat disposed at the blind sheet portion and extending substantially across the blind sheet portion, the at least one slat contributing to the rigidity of the blind, and at least one sealing portion disposed at at least one part of a periphery of the blind sheet portion for providing a seal between the blind sheet portion and a portion of the structure defining the opening when the blind is mounted in the opening. Also provided is a blind assembly comprising a blind and at least one bracket for for sealingly retaining the edge against a portion of a structure defining an opening.

### RELATED APPLICATIONS

The present application claims the benefit of U.S. Provisional Application No. 61/540,667 filed Sep. 29, 2011, the entire contents of which are incorporated herein by reference.

### FIELD OF THE DISCLOSURE

The present disclosure relates generally to blinds, and more particularly to blinds for insulating and/or sealing openings in structures.

### BACKGROUND

Many conventional blinds cover most of the opening in a structure. Such openings include window and door openings. However, many existing blinds and other opening coverings suffer heat loss at the edges thereof due to a gap between the edge or edges of the blind and the opening.

### SUMMARY

In one aspect, the present disclosure provides a blind for an opening defined by a structure, the blind comprising a flexible blind sheet portion, at least one slat disposed at the blind sheet portion and extending substantially across the blind sheet portion, the at least one slat contributing to the rigidity of the blind, and at least one sealing portion disposed at at least one part of a periphery of the blind sheet portion for providing a seal between the blind sheet portion and a portion of the structure defining the opening when the blind is mounted in the opening.

In another aspect, the present disclosure provides a blind assembly comprising a blind for an opening defined by a structure, the blind defining at least one mounting edge for mounting the blind in the opening, the blind also defining at least one peripheral edge opposite the at least one mounting edge, the blind comprising a flexible blind sheet portion, at least one slat disposed at the blind sheet portion and extending substantially across the blind sheet portion, the at least one slat contributing to the rigidity of the blind, and at least one sealing portion disposed at least along the at least one peripheral edge of the blind for providing a seal between the blind sheet portion at the at least one peripheral edge and a portion of the structure defining the opening when the blind is mounted in the opening, and at least one bracket coupleable to the structure defining the opening at or proximate the opening when the blind is mounted in the opening, the at least one bracket adapted for receiving the at least one peripheral edge of the blind for sealingly retaining the at least one peripheral edge against a part of the structure defining the opening.

### BRIEF DESCRIPTION OF THE DRAWINGS

The present disclosure will be better understood having regard to the drawings in which:

FIG. 1 is a plan view of one embodiment of the blind according to the present disclosure;

FIG. 2 is a perspective view of the embodiment shown in FIG. 1 disposed in a window frame;

FIG. 3 is a cut-away perspective view of another embodiment of the blind according to the present disclosure showing means for securing the blind in an opening in a structure;

FIG. 4A is a cross-sectional side view of another embodiment of the blind according to the present disclosure shown in an extended position; and

FIG. 4B is a cross-sectional side view of the embodiment illustrated in FIG. 4A shown in a retracted position.

### DETAILED DESCRIPTION

The present disclosure is described in one embodiment in the following disclosure with reference to the Figures. While this embodiment is described in the context of a blind for a window opening, the scope of the present disclosure is not intended to be limited to blinds for window openings. The present disclosure can be used with other openings in structures, including but not limited to door openings.

The present disclosure provides a blind comprising a blind sheet portion, at least one slat, and at least one sealing portion disposed at at least one part of a periphery of the blind sheet portion. In at least one embodiment, the blind provides an insulation value of about R8.

The blind sheet portion can comprise at least one sheet of material for filling in part or all of an opening defined by a structure. The at least one blind sheet can insulate against heat transfer, such as, but not limited to, bubble wrap. To further reduce heat transfer, a heat-reflective material may be disposed on at least one side of the blind sheet portion. The heat-reflective material can be any suitable material, such as, but not limited to, airfoil. In addition, the blind sheet portion may be opaque. Alternatively the blind sheet portion can be transparent, for example to allow sunlight to pass therethrough. The blind sheet portion may also be colour-coordinated for decorative purposes.

Disposed at the body of the blind sheet portion are one or more slats, which contribute to the rigidity of the blind, when it is mounted or otherwise disposed in an opening. Where the blind comprises more than one slat, the slats may be spaced at regular intervals about the blind sheet portion. Any number of slats may be used. In at least one embodiment, it is desirable that the blind remains rigid when installed at an opening, for example while it is hanging vertically in an opening. The one or more slats may be made of any suitable material that helps to contribute to the rigidity of the blind. As an example, a slat may be made of a composite material or a natural material (for example, but not limited to, wood). Furthermore, the one or more slats can be disposed and retained about the blind sheet portion by any suitable method.

One or more sealing portions are disposed at one or more parts of the periphery of the blind sheet portion. In at least one embodiment, the at least one sealing portion can provide a friction fit between the at least one sealing portion and a portion of the structure defining the opening. The friction fit thereby seals any gap between the at least one part of the periphery of the blind sheet portion and the structure defining the opening. This friction fit helps to minimize or eliminate the flow of air through the gap and thereby resists the transmission of heat around the blind.

The at least one sealing portion may be made of any material, including flexible material, and may be adapted to provide a friction fit between the blind and an opening. As an example, a sealing portion may comprise a strip of satin material. In at least one embodiment, the at least one sealing portion can provide for a fluid tight seal between the blind and the portion of the wall defining the window opening. Furthermore, in at least one embodiment, the at least one sealing portion may be affixed to the blind sheet portion using any suitable method.

In at least one embodiment of the present disclosure, the dimensions of the blind components, relative to the opening in a structure, can be as follows: the width of the blind sheet portion can be as close to the width of the opening as possible. The width of the combination of the at least one sealing portion and the blind sheet portion can be slightly greater than the width of the opening. The length of the at least one slat may be less than or equal to the width of the blind sheet portion.

According to another aspect of the present disclosure, at least one bracket can be coupled or otherwise secured to the structure defining the opening at or proximate the opening. The at least one bracket can be adapted to receive at least one peripheral edge of the blind. The at least one bracket may provide for additional sealing between the blind and at least one portion of the structure defining the opening. The at least one bracket can be coupled or secured to the structure at or proximate the window opening using any suitable method, including but not limited to screws and double-sided adhesive tape.

Moreover, the blind may be mounted or otherwise secured at an opening defined by a structure (e.g. a window or door opening) using any suitable method.

Furthermore, the blind can be retractable and extendable according to any suitable method or technique. For example, the blind can be upwardly retractable from a hanging position.

The various features and components of the present disclosure are now described with reference to the Figures.

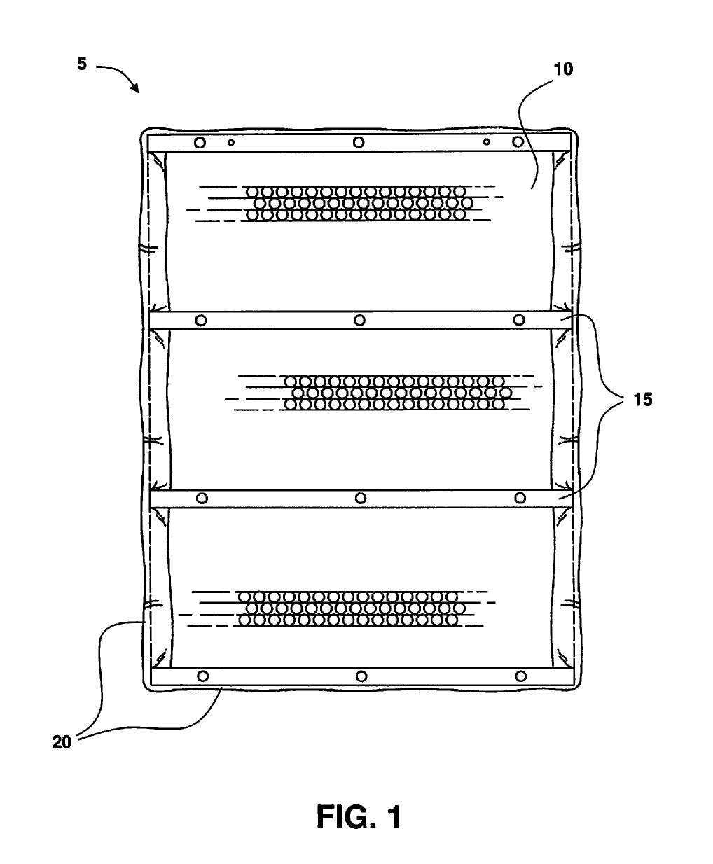

Reference is made to FIG. 1, which shows a plan view of one embodiment of the blind according to the present disclosure. Blind 5 is shown in a hanging position and comprises a blind sheet portion 10, four slats 15 spaced evenly from top to bottom of blind sheet portion 10, and one or more sealing portions 20 around the periphery of blind sheet portion 10. Although this particular embodiment has four slats, any suitable number of slats may be used. Again, one function of the one or more slats 15 is to contribute to the rigidity of blind 5. In addition, in at least one embodiment, as shown in FIG. 1, one or more sealing portions 20 are disposed around the entire periphery of blind sheet portion 10.

Slats 15 are shown to extend completely across blind sheet portion 10. In other words, the length of slat 15 is approximately equal to the width of the blind sheet portion 10. However, the at least one slat 15 need not extend completely across blind sheet portion 10. Furthermore, the at least one sealing portion 20 makes the dimension(s) (e.g. width and or height) of the blind 5 greater than the dimension(s) of blind sheet portion 10. In other words, at least one sealing portion 20 extends outwardly from the at least one part of the periphery of blind sheet portion 10. In addition, in at least one embodiment, as shown in the Figures, the at least one slat 15 can be aligned substantially transversely with a vertical axis of the blind when the blind is mounted in the opening.

In at least one embodiment, the at least one slat 15 can be affixed to blind sheet portion 10. Furthermore, in at least one embodiment, the at least one slat 15 may be affixed prior to, or after, the at least one sealing portion 20 is affixed or otherwise disposed at blind sheet portion 10.

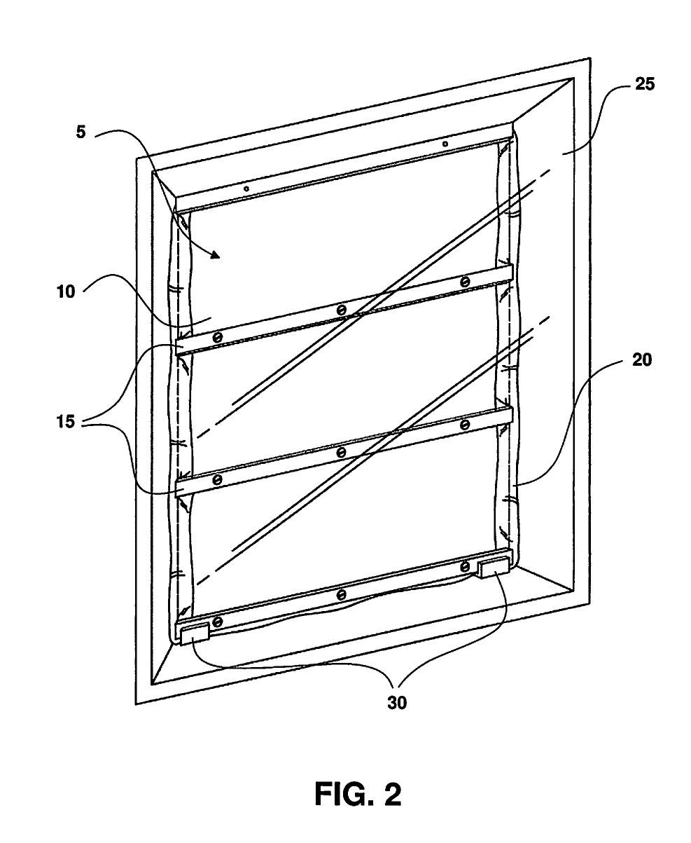

Reference is now made to FIG. 2, which shows a perspective view of the embodiment shown in FIG. 1 disposed in a window frame 25. One or more sealing portions 20 are adapted to sealingly engage the structure defining the opening, in this case window frame 25. To assist in maintaining a snug fit at the bottom of blind 5 is at least one bracket 30. The at least one bracket 30 is secured at or proximate the window opening. In this particular embodiment, a pair of brackets 30 is provided. Each bracket 30 is adapted to receive at least one peripheral edge of blind 5. In at least one embodiment, a slat can be disposed along a peripheral edge of the blind sheet portion, and the blind can be mounted in an opening such that this slat is located at or proximate the bottom of the opening. In this at least one embodiment, the at least one bracket 30 can be coupleable to the structure defining the opening at or proximate the opening. In particular, brackets 30 can be adapted to receive a bottom slat 15 of blind 5. The at least one sealing portion 20 can provide a sealing friction fit between the at least one peripheral edge of blind sheet portion 10 and window frame 25. While the embodiment shown in FIG. 2 comprises at least one sealing portion 20 on the sides and bottom of blind sheet portion 10, the top-most edge of blind sheet portion 10 may also comprise at least one sealing portion.

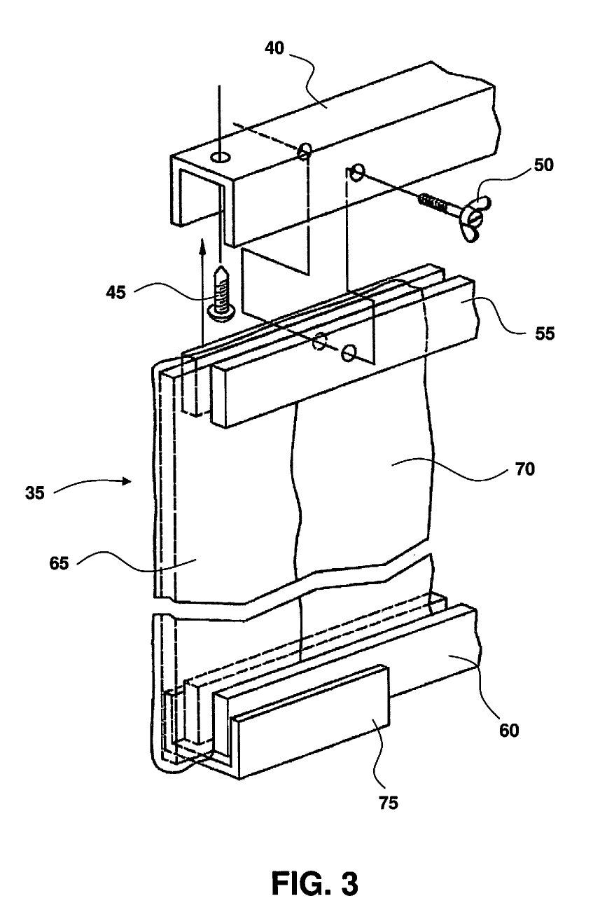

FIG. 3 shows a cut-away perspective view of one way to secure a blind 35 to window frame (not shown). One or more brackets can be used, and each bracket can define a re-entrant portion along its longitudinal axis for receiving at least one peripheral edge of blind 35. In this embodiment, a first U-shaped bracket 40 is disposed at the upper portion of the window frame. One or more screws 45 can be used to fasten first U-shaped bracket 40 to the window frame, while one or more pins 50 can be used to attach blind 35 to first U-shaped bracket 40. As an example, one or more pins 50 may traverse through one or more holes provided in a top-most slat 55 of blind 35 and first U-shaped bracket 40, thereby attaching blind 35 to bracket 40. Here top-most slat 55 can be disposed at or proximate a first peripheral edge of blind sheet portion 70. Meanwhile a bottom-most slat 60 is receivable into a second U-shaped bracket 75. Similarly, bottom-most slat 60 can be disposed at or proximate a second peripheral edge of blind sheet portion 70, where the second peripheral edge is opposite the first peripheral edge. A friction fit between blind 35 and the window frame (not shown) can be provided by the at least one sealing portions 65 of blind 35.

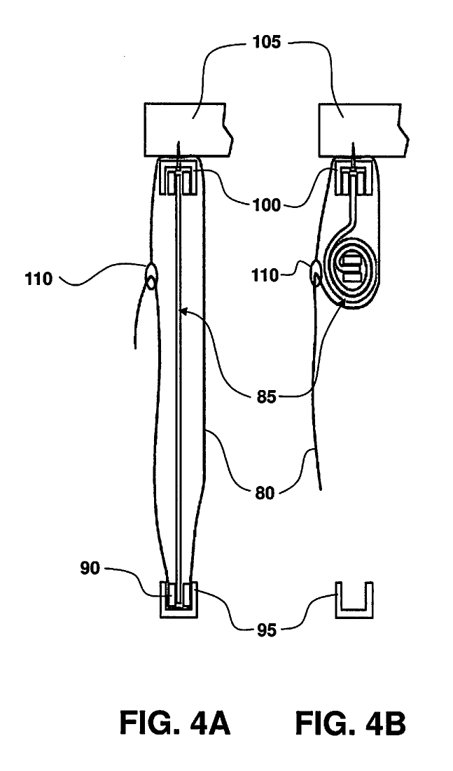

Reference is now made to FIG. 4A and FIG. 4B, which show a cross-sectional side view of a blind in an extended (e.g. a hanging) and retracted position, respectively.

As shown in FIG. 4A, a cord 80 surrounds the blind 85. At the bottom of blind 85, cord 80 slips between a lower sealing portion 90 and a lower bracket 95. At the top, cord 80 slips between a U-shaped bracket 100 and an upper window frame 105. A first end of cord 80 is secured to a second end of cord 80 by securing means 110.

In order to retract blind 85, cord 80 is pulled, thereby causing blind 85 to be pulled towards U-shaped bracket 100. As shown in FIG. 4B, in at least one embodiment the pulling of cord 80 can cause blind 85 to roll up as it is pulled towards U-shaped bracket 100.

Other suitable methods may be used to retract (and extend) the blind.

The embodiments described herein are examples of structures and assemblies having elements corresponding to elements of the techniques of this application. This written description may enable those skilled in the art to make and use embodiments having alternative elements that likewise correspond to the elements of the techniques of this application. The intended scope of the techniques of this application thus includes other structures, assemblies, systems or methods that do not differ from the techniques of this application as described herein, and further includes other structures, systems or methods with insubstantial differences from the techniques of this application as described herein

Moreover, the previous detailed description is provided to enable any person skilled in the art to make or use the present invention. Various modifications to those embodiments will be readily apparent to those skilled in the art, and the generic principles defined herein may be applied to other embodiments without departing from the spirit or scope of the invention described herein. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed:

1. A blind for an opening defined by a structure, the blind comprising:
a flexible blind sheet portion;
at least one slat disposed at the blind sheet portion and extending substantially across the blind sheet portion, the at least one slat contributing to the rigidity of the blind; and
at least one sealing portion disposed at at least one part of a periphery of the blind sheet portion for providing a seal between the blind sheet portion and a portion of the structure defining the opening when the blind is mounted in the opening.

2. The blind of claim 1 wherein the at least one sealing portion extends outwardly from the at least one part of the periphery of the blind sheet portion.

3. The blind of claim 1 wherein the at least one sealing portion extends substantially around the entire periphery of the blind sheet portion.

4. The blind of claim 1 wherein the blind sheet portion defines four peripheral edges, and wherein the at least one sealing portion extends substantially along at least three of the four peripheral edges of the blind sheet portion.

5. The blind of claim 1 wherein the at least one sealing portion provides for a friction fit between the at least one sealing portion and the portion of the structure defining the opening when the blind is mounted in the opening.

6. The blind of claim 1 wherein the at least one sealing portion is flexible for providing a substantially fluid tight seal between the blind and a portion of the structure defining the opening when the blind is mounted in the opening.

7. The blind of claim 1 wherein the at least one slat is aligned substantially transversely with a vertical axis of the blind when the blind is mounted in the opening.

8. The blind of claim 1 comprising a plurality of spaced apart slats.

9. The blind of claim 1 wherein a first slat is disposed at or proximate and extends along a first peripheral edge of the blind sheet portion.

10. The blind of claim 9 wherein a second slat is disposed at or proximate and extends along a second peripheral edge of the blind sheet portion, the second peripheral edge being substantially opposite the first peripheral edge.

11. The blind of claim 10 wherein the second peripheral edge is spaced apart from and substantially parallel to the first peripheral edge.

12. The blind of claim 1 wherein the blind sheet portion resists the transmission of heat therethrough.

13. The blind of claim 1 wherein a heat reflective material is disposed on at least one side of the blind sheet portion.

14. The blind of claim 1 wherein the blind is extendible and retractable.

15. A blind assembly comprising:
a blind for an opening defined by a structure, the blind defining at least one mounting edge for mounting the blind in the opening, the blind also defining at least one peripheral edge opposite the at least one mounting edge, the blind comprising:
a flexible blind sheet portion;
at least one slat disposed at the blind sheet portion and extending substantially across the blind sheet portion, the at least one slat contributing to the rigidity of the blind; and
at least one sealing portion disposed at least along the at least one peripheral edge of the blind for providing a seal between the blind sheet portion at the at least one peripheral edge and a portion of the structure defining the opening when the blind is mounted in the opening; and
at least one bracket coupleable to the structure defining the opening at or proximate the opening when the blind is mounted in the opening, the at least one bracket adapted for receiving the at least one peripheral edge of the blind for sealingly retaining the at least one peripheral edge against a part of the structure defining the opening.

16. The blind assembly of claim 15 wherein the at least one bracket defines a re-entrant portion along its longitudinal axis for receiving the at least one peripheral edge of the blind.

17. The blind assembly of claim 15 wherein the at least one sealing portion extends substantially around an entire periphery of the blind.
